(19) United States
(12) Patent Application Publication
(10) Pub. No.: US 2012/0076307 A1
(43) Pub. Date: Mar. 29, 2012

(54) PROCESSING OF AUDIO CHANNELS

(75) Inventors: Albertus Cornelis Den Brinker, Eindhoven (NL); Aki Sakari Harma, Eindhoven (NL)

(73) Assignee: KONINKLIJKE PHILIPS ELECTRONICS N.V., EINDHOVEN (NL)

(21) Appl. No.: 13/375,035

(22) PCT Filed: May 31, 2010
(86) PCT No.: PCT/IB2010/052412

§ 371 Date: Nov. 29, 2011

(30) Foreign Application Priority Data
Jun. 5, 2009 (EP) 09161998.1

(51) Int. Cl. H04R 5/00

(52) U.S. Cl. 381/17

(57) ABSTRACT

An audio apparatus comprises a processor (101) for providing a set of audio channels. A prediction circuit (103) generates a predicted signal for a first channel by adaptive filtering of a second channel by an adaptive filter. An adaptation processor (105) adapts the adaptive filter to minimize a cost function indicative of a difference between the predicted signal and the first channel. A compensation processor (107) then generates a non-predicted signal by compensating the first signal for the predicted signal and a distribution processor (109) generates an output set of audio channels by distributing at least the predicted signal and the non-predicted signal over the output set of audio signals where the distribution is different for the predicted signal and the non-predicted signal. The cross-channel predictive filtering provides signal components that represent different spatial characteristics of the originating sound and which are therefore advantageously distributed differently for the output channels.

### FIELD OF THE INVENTION

The invention relates to a generation of a set of output audio channels from another set of audio channels, and in particular, but not exclusively to upmixing from a stereo signal to a multi-channel signal with more than two channels.

### BACKGROUND OF THE INVENTION

Spatial audio reproduction based on more than two audio channels has become increasingly prevalent in the last decade. For example, multi-channel spatial surround sound systems using five or more sound source positions have become very popular and for example home cinema systems have become a highly successful product in the consumer market.

As a consequence, an increasing amount of research has gone into developing techniques and algorithms that can improve performance or provide additional flexibility for spatial surround systems.

For example, one problem associated with such spatial systems is that a lot of legacy content and audio material has been captured in a conventional stereo format and therefore it would be advantageous for a system to be able perform a format conversion from the two channels of a stereo signal to the higher number of channels of most spatial surround systems.

Also, in many scenarios it is desirable that the spatial audio content is optimized or improved. For example, it may often be desirable to provide an enhanced differentiation between different sound sources by ensuring that central sound sources are concentrated in the main channel while non-central sound sources are (further) represented in the side channels. This may for example provide improved clarity of speech for many home cinema systems.

The extension of a set of channels to a larger set of channels is usually referred to as upmixing and various approaches for such format conversion have been proposed.

For example, a simple way of upmixing a stereo signal to five spatial channels is to use a 5 by 2 matrix that maps the two stereo signals to the five output signals. Such an approach is low complexity and thus represents a low cost solution but also tends to provide a relatively low quality.

An extension of this approach is to use several upmixing matrices where each matrix has a separate weight determined from a signal characteristic. The weights may e.g. be determined from energy characteristics of the stereo signal to be upmixed. However, although this provides an improvement, the sound quality still tends to be suboptimal and the approach may substantially increase complexity. In general, such techniques are called adaptive matrixing.

Another approach has been proposed in R. Irwan and R. M. Aarts, “Two-to-five channel sound processing.” Journal of the Audio Engineering Society, Vol. 50 (11), pp. 914-926, 2002. This approach uses principal component analysis as a tool to define the dominant source position. Subsequently, the values of the adaptive up-mix matrix are steered by the dominant source positions. However, although high quality may generally be achieved, the performance may in some scenarios not be optimal and the approach is relatively complex. For example, typical audio comprises many sound sources and as the algorithm does not take any time-differences into account, the spatial image may from time to time exhibit some distortion.

More elaborate techniques for analyzing the stereo content are also known. However, although these techniques and approaches may improve quality, they tend to be relatively complex and still tend to provide suboptimal audio quality in many scenarios. For example, the MPEG Surround decoder standard includes an upmix mode (the blind upmix mode) which may perform an upmix without relying on transmitted spatial parameters. However, the approach involves decomposition of both channels of the stereo signal into time-frequency tiles which is computationally demanding and introduces a considerable delay.

Hence, an improved system would be advantageous and in particular an approach for generating a set of audio channels from a set of input channels allowing increased flexibility, improved audio quality, reduced complexity, facilitated implementation and/or operation, reduced resource requirements, and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for generating a set of output audio channels from a first set of audio channels, the apparatus comprising: providing circuit for providing the first set of audio channels; prediction circuit for generating a predicted signal for a first channel of the first set of audio channels by adaptive filtering of a signal of a second channel of the first set of audio channels by an adaptive filter; circuit for adapting the adaptive filter to minimize a cost function indicative of a difference between the predicted signal and a first signal of the first channel; circuit for generating a non-predicted signal for the first channel by compensating the first signal for the predicted signal; distributing circuit for generating the set of output audio channels by distributing at least the predicted signal and the non-predicted signal over the set of output audio signals, the distribution being different for the predicted signal and the non-predicted signal.

The invention may allow an improved generation of an output set of audio channels. An improved quality may be achieved in many scenarios and/or a reduced complexity and/or resource consumption and/or reduced algorithmic delay may be achieved. In many embodiments an improved spatial experience may be achieved.

The system may e.g. use cross-channel predictive filtering to determine correlation information that can be used to optimize the distribution of different signal components of the first set of channels to the set of output channels. In particular, the predictive and non-predictive sound components may correspond to components having substantially different spatial characteristics and which accordingly may advantageously be distributed differently. For example, the approach may provide a low complexity approach for estimating signal components corresponding to spatially well defined sound sources and signal components corresponding to ambient and diffuse sound sources with no well defined spatial location. As another example, the approach may provide a low complexity approach for estimating signal components corresponding to centrally positioned sound sources and signal components corresponding to non-centrally positioned sound sources.

The approach may specifically provide improved upmixing of audio channels. Indeed, in some embodiments, the output set of audio channels may comprise more audio channels than the first set of audio channels. The first set of audio channels may specifically comprise a set of stereo channels or channels derived from a set of stereo channels.

It will be appreciated that any suitable cost function may be used. Furthermore, it will be appreciated that the minimization of the cost function may not be an absolute and mathematically precise minimization but may simply be any approach that seeks to reduce the cost function while taking into account other constraints, such as e.g. resource restrictions, practical limitations etc. Thus, the term minimization is used in its weak sense typically applied in the technical rather than it its strict mathematical sense. It will also be appreciated that a cost function may be minimized indirectly by optimizing a function indicative of a desired characteristic. For example, the cost function can be minimized by maximizing a measure of the mutual information or correlation between the predicted signal and the first signal.

The adaptive filter may include additional processing of the signal, such as e.g. gain adjustment or range limiting. Also, the adaptive filter may comprise an adaptive filter part and a non-adaptive filter part. For example, the adaptive filter part may be preceded by a pre-filter and followed by a post filter. The pre-filter and/or the post filter may be fixed static filters.

In some embodiments, the invention may provide improved separation of different signal components. For example, in some embodiments, the invention may provide an improved separation and focusing of central sound sources in a center channel.

In accordance with an optional feature of the invention, the providing circuit is arranged to generate a difference signal from a first spatial channel and a second spatial channel, and wherein the first channel comprises the difference signal.

This may provide improved performance in many embodiments. In particular, the division of a difference signal into a predicted and non-predicted signal component may provide signals that are particularly suitable for distribution to different spatial channels to reflect different characteristics of the sounds sources in the stereo signal. The first and second spatial channels may specifically be left and right channels of e.g. a stereo signal.

In accordance with an optional feature of the invention, the distributing circuit is arranged to distribute the predicted signal such that a predicted signal power in at least one spatial front side channel of the set of output audio channels is at least twice as high as a predicted signal power in any spatial surround channel or spatial front center channel of the set of output audio channels.

This may provide improved performance in many embodiments. In particular, it may provide an improved spatial experience and may allow the spatial position of well defined sources to increasingly maintain their position from the original stereo signal.

In accordance with an optional feature of the invention, the distributing circuit is arranged to distribute the non-predicted signal such that a non-predicted signal power in at least one spatial side channel or surround channel of the set of output audio channels is at least twice as high as a non-predicted signal power in a spatial front center channel of the set of output audio channels.

This may provide improved performance in many embodiments. In particular, it may provide an improved spatial experience and may allow the sound likely to not correspond to well-defined spatial positions to be distributed such that they may provide a surround experience.

In accordance with an optional feature of the invention, the distributing circuit is arranged to distribute the non-predicted signal such that a variation in non-predicted signal power between any two channels of the spatial side channels and surround channels of the set of output audio channels is no more than 6 dB.

This may provide improved performance in many embodiments and may in particular provide a more immersive surround experience in many scenarios.

In accordance with an optional feature of the invention, the providing circuit is arranged to generate a sum signal from a first spatial channel and a second spatial channel, and wherein the second channel comprises the sum signal.

This may provide improved performance in many embodiments. In particular, the predictive filtering being applied to a sum signal to generate a predicted signal for another channel may provide a predicted signal which is particularly indicative of well defined sources that may be present in a plurality of channels. It may specifically provide an improved separation of the first signal into a predicted component corresponding to well defined sound source positions and a non-predicted component corresponding to diffuse ambient sounds (such as room reverberations).

The first and second spatial channels may specifically be left and right channels of e.g. a stereo signal.

The use of a sum signal for the second channel may specifically be combined with the use of a difference signal for the first channel to provide particularly advantageous operation and performance.

In accordance with an optional feature of the invention, the providing circuit is arranged to generate a sum signal from a first spatial channel and a second spatial channel, and wherein the first channel comprises the sum signal.

This may provide improved performance in many embodiments. In particular, the division of a sum signal into a predicted and non-predicted signal component may provide signals that are particularly suitable for distribution to different spatial channels to reflect different characteristics of the sounds sources in the stereo signal.

The first and second spatial channels may specifically be left and right channels of e.g. a stereo signal.

In accordance with an optional feature of the invention, the distributing circuit is arranged to distribute the non-predicted signal such that a non-predicted signal power in at least one spatial front center channel of the set of output audio channels is at least twice as high as a non-predicted signal power in any spatial front side channel of the set of output audio channels.

This may provide particularly advantageous operation and/or performance in many scenarios. Specifically, it may allow an improved allocation of centrally positioned sound sources to a center channel.

In accordance with an optional feature of the invention, the distributing circuit is arranged to distribute the predicted signal such that a predicted signal power in at least one spatial front side channel of the set of output audio channels is at least twice as high as a predicted signal power in a spatial front center channel of the set of output audio channels.

This may provide particularly advantageous operation and/or performance in many scenarios. Specifically, it may allow an improved allocation of non-centrally positioned sound sources to side channels while maintaining a front positioning of the sound sources.

In accordance with an optional feature of the invention, the providing circuit is arranged to generate a difference signal from a first spatial channel and a second spatial channel, and wherein the second channel comprises the difference signal.

This may provide improved performance in many embodiments. In particular, the predictive filtering being applied to a difference signal to generate a predicted signal for another channel, such as a sum signal, may provide a predicted signal which is particularly indicative of non-centrally positioned sources and a non-predicted signal that is particularly indicative of centrally position sources.

The first and second spatial channels may specifically be left and right channels of e.g. a stereo signal.

The use of a difference signal for the second channel may specifically be combined with the use of a sum signal for the first channel to provide particularly advantageous operation and performance.

In accordance with an optional feature of the invention, the first channel corresponds to one of the first spatial channel and the second spatial channel.

This may provide improved performance and/or facilitated operation in many embodiments. In particular, it may in many cases provide an improved separation into centrally and non-centrally positioned sound sources that may be distributed differently to provide an improved sound staging. For example, it may provide an improved focus of central sound sources, such as e.g. speech.

The first and second spatial channels may specifically be left and right channels of e.g. a stereo signal.

In accordance with an optional feature of the invention, the distributing circuit is arranged to distribute the predicted signal to a spatial channel of the set of output channels corresponding to one of the first spatial channel and the second spatial channels with a gain factor of at least twice a gain factor for the non-predicted signal.

This may provide an improved performance in many scenarios. In particular, it may allow that the spreading of a central position over side channels is reduced and may provide a more specific perceived position corresponding to a position for a center channel.

In accordance with an optional feature of the invention, the distributing circuit is arranged to distribute the non-predicted signal to a spatial center channel of the set of output channels with a gain factor of at least twice a gain factor for a spatial channel of the set of output channels corresponding to the one of the first spatial channel and the second spatial channel.

This may provide an improved performance in many scenarios. In particular, it may allow that the smearing of a central position over side channels is reduced and may provide a more specific perceived position corresponding to a position of a speaker for a center channel.

In accordance with an optional feature of the invention, the prediction circuit is arranged to generate the predicted signal as a delayed predicted signal.

This may allow improved performance in many scenarios and may in particular allow a more accurate prediction of the first signals from the signal of the second channel by including both past and future samples of the signals when adapting the adaptive filter.

According to an aspect of the invention there is provided a method of generating a set of output audio channels from a first set of audio channels, the method comprising: providing the first set of audio channels; generating a predicted signal for a first channel of the first set of audio channels by adaptive filtering of a signal of a second channel of the first set of audio channels by an adaptive filter; adapting the adaptive filter to minimize a cost function indicative of a difference between the predicted signal and a first signal of the first channel; generating a non-predicted signal for the first channel by compensating the first signal for the predicted signal; generating the set of output audio channels by distributing at least the predicted signal and the non-predicted signal over the set of output audio signals, the distribution being different for the predicted signal and the non-predicted signal.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of elements of an audio apparatus for generating a set of output channels from another set of channels in accordance with some embodiments of the invention;

FIG. 2 illustrates an example of elements of an audio apparatus for generating a set of output channels from another set of channels in accordance with some embodiments of the invention;

FIG. 3 illustrates an example of a distribution of signals to output channels in accordance with some embodiments of the invention;

FIG. 4 illustrates an example of elements of an audio apparatus for generating a set of output channels from another set of channels in accordance with some embodiments of the invention;

FIG. 5 illustrates an example of a distribution of signals to output channels in accordance with some embodiments of the invention;

FIG. 6 illustrates an example of elements of an audio apparatus for generating a set of output channels from another set of channels in accordance with some embodiments of the invention; and

FIGS. 7-9 illustrate examples of audio signals that may be present in an audio apparatus for generating a set of output channels from another set of channels in accordance with some embodiments of the invention.

### DETAILED DESCRIPTION OF SOME EMBODIMENTS OF THE INVENTION

The following description focuses on embodiments of the invention applicable to upmixing of a stereo channel to a multi-channel signal with more than two spatial channels. However, it will be appreciated that the invention is not limited to this application but may be applied to many other audio processing systems.

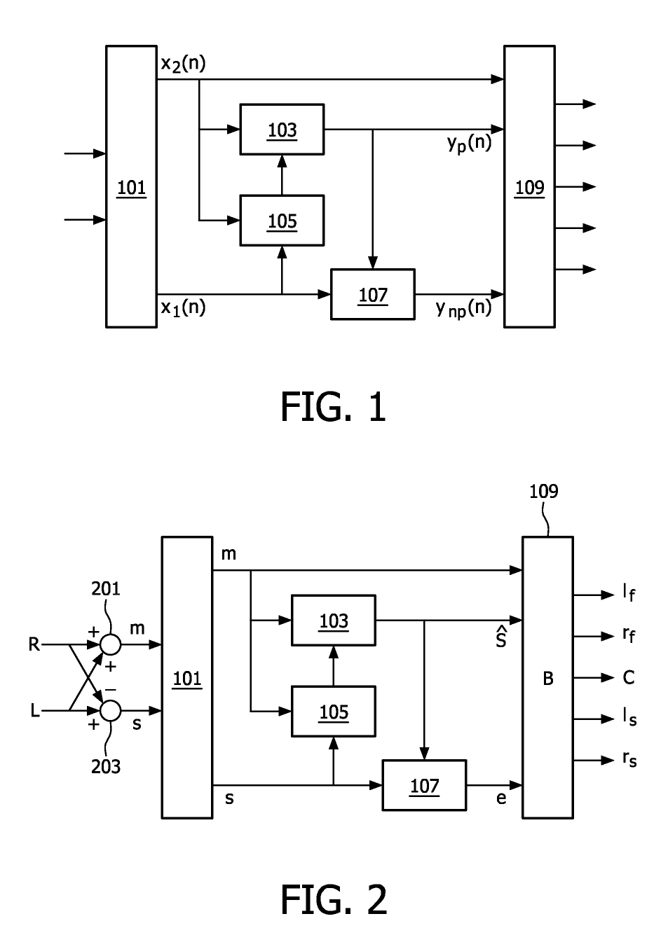

FIG. 1 illustrates an example of an audio apparatus for generating a set of output channels from a set of input channels. The audio apparatus uses a cross-channel predictive filtering to divide a signal into a predictive part and a non-predictive part.

Thus, a predicted signal is generated for a first signal from a first channel by filtering a second signal from a second channel by an adaptive filter. The adaptive filter is adapted to result in a predicted signal which resembles the first signal as much as possible and thus reflects the correlation between the first and the second filter. The predicted signal component may thus reflect a component of the first signal which may also be present in at least one other channel. Such a scenario may e.g. be due to the component arising from one or more specific audio sources with a well defined position and therefore is likely to be correlated between different spatial channels. The remaining non-predicted signal however may be likely to arise from distributed, diffuse, and less well defined sound sources and may accordingly be likely to represent ambient sounds. Thus, the separation into the predicted and non-predicted signals based on cross-channel prediction allows the first signal to be divided into signals representing different types of sound with different spatial characteristics.

The system of FIG. 1 proceeds to distribute the predicted and non predicted signals differently over the output channels. For example, the predicted signal may be predominantly distributed to specific spatial channels that allow the perception of a well defined sound source position whereas the non-predicted signal may be distributed more widely and specifically may be spread over more channels including channels that are aimed at providing a surround ambient experience.

For brevity and clarity, FIG. 1 illustrates an example of only one channel being divided into a predicted signal and a non-predicted signal based on one other channel. However, it will be appreciated that in other embodiments, the same approach may be applied to a plurality of the channels and that indeed one signal/channel may be split into predicted and non-predicted signal(s) based on a plurality of other channels.

In the example of FIG. 1, a plurality of signals is received by a receiver 101 from one or more internal or external sources. A first signal xₗ(n) is then divided into a predicted signal component yₚ(n) and a non-predicted signal component yₙₚ(n) based on an adaptive predictive filtering of a second signal x₂(n).

The second signal x₂(n) is fed to an adaptive filter 103 which is arranged to filter the second signal x₂(n) to generate a predicted signal yₚ(n). The adaptive filter 103 is in the specific example an adaptive FIR (Finite Impulse Response) filter. The filter coefficients for the adaptive filter 103 are provided by an adaptation processor 105 which generates the filter coefficients such that they minimize a cost function indicative of a difference between the first signal xₗ(n) and the resulting predicted signal yₚ(n) (e.g. by maximizing a measure of the mutual information between the first signal xₗ(n) and the resulting predicted signal yₚ(n)). Thus, the adaptive filter 103 is adapted by the adaptation processor 105 such that the predicted signal yₚ(n) resembles the first signal xₗ(n) as closely as is possible by a filtering of the second signal x₂(n). Thus the predicted signal represents signal components of the first signal xₗ(n) that correlate between the two channels.

It will be appreciated that the adaptive filter 103 may comprise other processing and may comprise non-adaptive processing but that it comprises at least one adaptive filtering process. For example, the adaptive filtering may include a fixed pre-filtering of the second signal x₂(n) prior to it being filtered by an adaptive filter part. The resulting signal may further be post-filtered by a fixed post-filter.

It will be appreciated that many different approaches and algorithms for predictive filtering of a signal are known and that any suitable approach and method may be used without subtracting from the invention. For example, the adaptive filter 103 may be implemented as a FIR filter but may alternatively or additionally include an IIR (Infinite Impulse Response) filter. It will also be appreciated that many different algorithms and methods for adapting an adaptive filter to provide predictive filtering are known and that any such suitable algorithm and approach may be used without detracting from the invention. For example, the adaptation processor 105 may use an LMS (Least-Mean-Squares), NLMS (Normalized Least-Mean-Squares) or RLS (Recursive Least-Squares) adaptation algorithm to determine the coefficients.

The apparatus of FIG. 1 is further arranged to generate a non-predicted signal yₙₚ(n) for the first signal xₗ(n). Thus, the apparatus comprises a compensation processor 107 which is arranged to generate the non-predicted signal yₙₚ(n) by compensating the first signal xₗ(n) for the predicted signal yₚ(n). The compensation processor 107 is coupled to the adaptive filter 103 and receives the predicted signal yₚ(n) therefrom. It is further coupled to the receiver 101 and receives the first signal xₗ(n) therefrom. It then proceeds to generate the non-predicted signal yₙₚ(n) by compensating the first signal xₗ(n) for the predicted signal yₚ(n). In the specific example, this compensation is a simple subtraction of the predicted signal yₚ(n) from the first signal xₗ(n), i.e. the non-predicted signal is given by:

yₙₚ(n)=xₗ(n)−yₚ(n)

The apparatus further comprises a distribution processor 109 which is coupled to the adaptive filter 103 and the compensation processor 107 and which receives the predicted and the non-predicted signals yₚ(n), yₙₚ(n). In the example, the distribution processor 109 is furthermore coupled to the receiver 101 and also receives the second signal x₂(n).

The distribution processor 109 is arranged to generate an output set of audio channels by distributing the predicted signal yₚ(n) and the non-predicted signal yₙₚ(n), and in the example also the second signal x₂(n) over the output set of audio signals. However, the distribution of the predicted signal yₚ(n) is different from the distribution of the non-predicted signal yₙₚ(n).

In particular, the distribution processor 109 may implement an effective gain from each of the signals it receives to each of the output channels and this gain may be different for the predicted signal yₚ(n) and the non-predicted signal yₙₚ(n) for at least one channel. In particular, the gain may be zero for some channels for e.g. the non-predicted signal yₙₚ(n) but not for the predicted signal yₚ(n) resulting in the predicted signal yₚ(n) being distributed to this channel but the non-predicted signal yₙₚ(n) not being distributed to it.

In some embodiments, the distribution may differ in other aspects such as for example by having different frequency responses for the predicted signal yₚ(n) and the non-predicted signal yₙₚ(n).

Since the predicted signal yₚ(n) and the non-predicted signal yₙₚ(n) represent different types of sound characteristics and specifically typically may represent different spatial characteristics, the distribution may be optimized to reflect this and may e.g. be used to provide an improved spatial user experience.

In the following, a specific example aimed at upmixing of stereo channels to a spatial multi-channel signal will be described in more detail. In the example, a five channel output signal is generated from a stereo input signal. Specifically, in the example a right (R) and left (L) signal is received and five spatial signals corresponding to the center (C), left front (l_{f}), right front (r_{f}), left surround (lₛ), and right surround (rₛ) are generated.

The specific system is illustrated in FIG. 2 and comprises the same elements as described above for FIG. 1. However, in the system of FIG. 2, the received stereo signals are not used directly but rather a first converted into a sum signal (typically referred to as a mid-signal) and a difference signal (typically referred to as a side signal). In the specific example, the mid (sum) signal m is generated as:

m=R+L

by a summation circuit 201. Similarly, the side (difference) signal is generated as

s=R−L

by a subtraction circuit 203.

It will be appreciated that the specific sum and difference (mid and side) signals may be different in other embodiments and in particular that weights may be applied to the left and right signals in the calculation of the sum and difference (mid and side) signals. It will also be appreciated that the functionality for generating the mid and side signals may be considered to be part of the receiver 101.

In the example, the mid and side signals are fed to the receiver 101 which proceeds to perform the predictive filtering described with reference to FIG. 1. In particular, a predicted signal and a non-predicted signal are generated for the side signal by an adaptive filtering of the mid signal. Thus, in the system a predictive filter is used to predict the side signal from the mid signal. This results in the predicted signal g and the non-predicted signal e. Thus, in comparison to the system of FIG. 1, first channel of FIG. 1 can be considered to comprise the difference/side signal s and the second channel can be considered to comprise the sum/mid signal m.

The predicted signal g plus the mid-signal m mainly contain information for sound sources that have a clear spatial position in the stereo recording. In contrast, the non-predicted signal e mainly contains information relating to diffuse sources (such as e.g. reverberation).

Thus, the predictive filter 103, 105 generates three signals from the original two signals. These three signals are then distributed to the five output signals by the distribution processor 109.

Specifically, the distribution processor 109 may apply a low complexity matrix multiplication using a distribution matrix U:

$$( \begin{matrix}{l}_{f} \\ {r}_{f} \\ c \\ {l}_{s} \\ {r}_{s}\end{matrix} ) = U ( \begin{matrix}m \\ \hat{s} \\ e\end{matrix} )$$

The distribution is specifically arranged to be such that an improved spatial experience is achieved by using a different channel distribution for the different parts of the signal. Thus, the qualitative distinction between the three signals is exploited in defining a simple mapping to the five output channels.

Indeed, in the system, the predicted signal is distributed such that it is predominantly presented from the front side speakers. Thus, the predicted signal is predominantly fed to preferably both the left and right front channels. In particular, advantageous performance and in particular an improved spatial experience has been found to be achieved when the signal power from a signal component in at least one front side channel arising from the predicted signal is at least twice as high as the predicted signal power from such a component in any of the spatial surround channels or the spatial front center channel. Indeed, in many embodiments, the predicted signal may be distributed only (and typically equally) to the front side channels.

Thus, the system specifically exploits that the predicted side signal g predominantly comprises information that is not common for the right and left channels and therefore represents non-centralized sound positions, yet is indicative of well defined sound source positions and therefore are likely to be intended to be presented at a specific position in front of the listener.

The distribution processor 109 may further be arranged to distribute the mid signal m to the front channels and specifically may predominantly distribute this to the center channel and the left and right front channels. This reflects that the sum signal of the right and left channels typically mainly comprises sound from sources that are correlated between the two channels and therefore is likely to correspond to sound intended to be reproduced from the front of the user.

Furthermore, the non-predicted signal is distributed such that it is presented rather diffusively. Indeed, the non-predicted signal may be distributed to all channels or more typically to all channels except for the center channel. This results in the non-predicted signal reaching the user from a variety of directions and predominantly from other directions than the direct front of the user. This provides a relatively diffuse and unfocussed spatial perception which is particularly desirable for a signal component that is likely to arise from diffuse ambient sounds, such as room reverberations.

In particular, it has been found that advantageous performance can be achieved when the variation in the power arising from the non-predicted signal between two front side channels or between two surround channels is no more than 6 dB. In addition, it has been found that advantageous performance can be achieved when the power arising from the non-predicted signal in one front side channel is between one and five times lower than the power arising in a surround channel.

Indeed, the distribution of the non-predicted side signal has been evaluated experimentally. It was found that in some scenarios focusing the signal entirely in the surround channels tended to result in too much signal from these positions. It was also found that an equal distribution to the front and surround side channels resulted in too little signal being perceived from the surround sources. A reasonable compromise was found for a quarter of the energy being provided to the front side channels with the remaining amount being distributed to the surround channels.

Also, it has been found to be particular advantageous for the power of the component arising from the non-predicted signal component in at least one of the side and surround channels to be at least twice as high as that in the front center channel.

The distribution of the different signals across the output channels thus reflect the specific characteristics of the sounds that the signals are likely to represent. Furthermore, the system distributes the signals such that they take into account the typical sound staging that is performed by a recording engineer when creating stereo recordings. For example, most musical recordings tend to place specific significant instruments at various specific locations in the sound stage in front of the user and then spread ambient noise or less significant instruments across the sound stage. The described system uses knowledge of this approach to expand the one dimensional sound stage to a two dimensional sound stage that surrounds the user while substantially maintaining the positioning of the main audio sources (e.g. the main instruments). The approach may thus provide a more immersive surround sound experience while still maintaining an accurate sound stage for individual sound sources.

Furthermore, the approach may be achieved with low complexity and may allow a very efficient implementation with a low computational resource cost. Indeed, the adaptive filtering may be performed in the time domain and the distribution processor 109 may implement a simple matrix operation which is applied to the signal in the time domain. Thus, the distribution and upmixing does not require any frequency transforms or any characterization or processing of individual time-frequency blocks.

As a specific example, the distribution processor 109 may for example implement a simple matrix U given as:

$$U = \frac{1}{\sqrt{2}} ( \begin{matrix}b & f & d \\ b & - f & - d \\ a & 0 & 0 \\ 0 & d & d \\ 0 & - d & - d\end{matrix} )$$

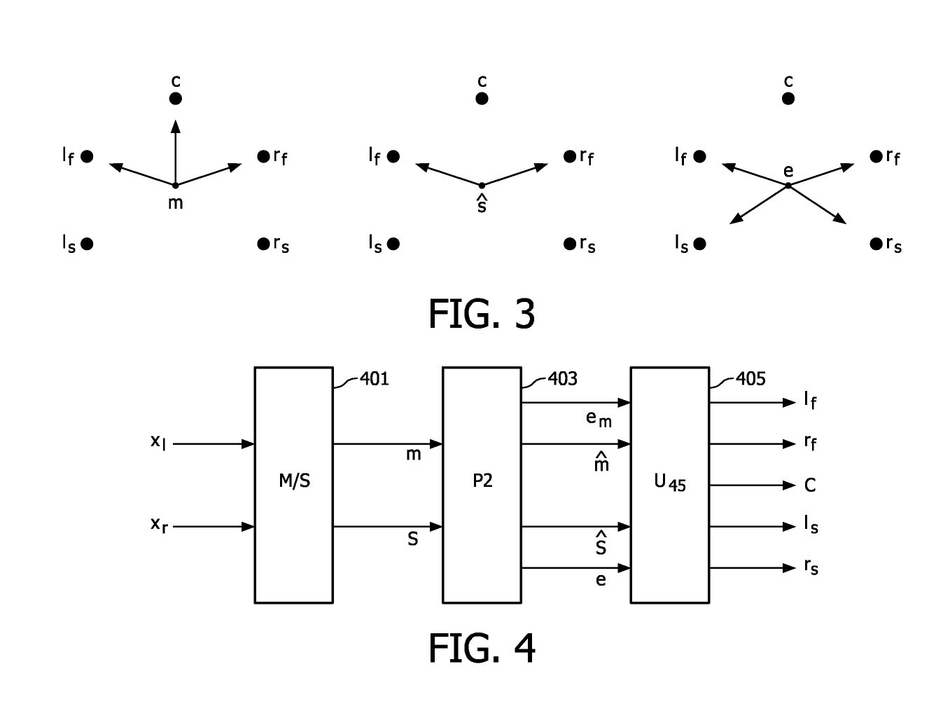

The corresponding distribution of channels is shown in FIG. 3.

The coefficients a, b, d, f can specifically be chosen such that the total energy of the signals m, ŝ and e corresponds to that of the five output signals. For instance,

$$a = f = \frac{\sqrt{2}}{2} ,$$

b=d=0.5. The scaling factor for the matrix is introduced to compensate for the energy increase due to mapping of the left and right signals into the mid and side signals.

Thus, the system uses a low resource cost method for channel format conversion which is based on a consideration of an audio signal as representing two different classes of sounds. The first class is associated with well-defined sound sources that each has a specific spatial position. The second class consists of the more ambient sounds, i.e., sounds or sound components lacking a clear spatial position. This separation is particularly valuable for a format conversion in the following sense. When doing a format conversion, it is desired that the well-defined audio sources maintain substantially the same spatial position when converted. However, the position of the ambient audio content can be manipulated much more freely.

Therefore, the system uses a two-step procedure consisting of a low resource cost estimation of ambient and non-ambient signal parts followed by substantially different mappings of the ambient and non-ambient signal parts to the output channels. The ambient and non-ambient signals are obtained by cross-channel adaptive filtering that splits the signal into a predictable and unpredictable component. This splitting of the signal is essentially performed over the whole band (avoiding time-frequency analysis) and involves a low resource cost adaptive filter. The predictable and unpredictable components provide a good estimate of the non-ambient and ambient signals, respectively. The splitting into predictable and unpredictable components has the advantage that relations between channels are captured which makes it possible to much better maintain the spatial stereo image when distributing these components over the output channels.

The next step is the mapping of these components to the intended format or reproduction system. This mapping or distribution of the signal components is substantially different for the ambient and non-ambient signal components, i.e., each signal component is associated with its own set of distribution factors.

These mappings depend on the original format and the intended format or reproduction system. However, in the specific example, the distribution of mid and the predictable side signal is such that the spatial image is substantially maintained i.e., they are predominantly distributed to the front channels. In contrast, the unpredictable part of the side signal does not yield a clear spatial image, i.e., it has a more ambient character, and can be mapped to front and rear channels or predominantly to the rear channels thereby creating an increased immersive surround experience.

The predictive filter may specifically be generated by generating a number of regressor signals yᵢ (i=1, . . . , K) by linear filtering. This may e.g. be by a tapped delay line, an all-pass filter, etc. The predicted signal ŝ may then be generated as a linear combination of these regressor signals:

$$\hat{s} ( n ) = {\sum }_{i = 1}^{K} {w}_{i} ( n ) {y}_{i} ( n )$$

where the weights wᵢ may be generated using a suitable adaptation algorithm such as the RLS or NLMS algorithm.

In some embodiments, the prediction may generate the predicted signal as a delayed predicted signal, Thus, it may predict a delayed version of the side signal. i.e., it may generate the signals ŝ(n−D) and e(n−D) where D is a suitable delay. This may allow the prediction to be based on both future and past samples (for both the mid and the side signals). If such a delay is applied it may be necessary to synchronize the signals fed to the distribution processor 109 and in particular the mid signal may be delayed by a duration D.

In the previous example, predicted and non-predicted signal components were generated for the side signal. However, alternatively or additionally, predicted and non-predicted signal components may be generated for the mid signal.

Indeed, in some embodiments, a predicted signal component for the mid signal may be generated by adaptive filtering of the side signal. A non-predicted signal may then be generated by compensating the mid signal for this predicted signal. The distribution of the predicted and the non-predicted parts of the mid signal may then be distributed differently over the output channels. Such an approach may be independent of the processing of the side signal and specifically may be performed without any such analysis or separation being performed for the side signal. As a specific example, the distribution processor 109 may receive the predicted mid signal, the non-predicted mid signal, and the side signal and may proceed to apply a 3-by-5 matrix to generate the output channels.

However, in many embodiments, improved performance can be achieved by splitting both the mid and side signal. Thus, in addition to generating the predicted side signal ŝ and the non-predicted side signal e by adaptive filtering the mid signal, the system may also generate the predicted mid signal \hat{m} and the non-predicted mid signal eₘ by adaptive filtering the side signal s. Thus, in this example, four signals are provided to the distribution processor 109.

An example of such a system is shown in FIG. 4. In the example, the right and left input signals are fed to a mid/side processor 401 which generates the mid and side signals as described for the system of FIG. 2. The mid and side signals are then fed to a prediction processor 403 which generates the predicted side signal ŝ, the non-predicted side signal e, the predicted mid signal, _{\hat{m}} and the non-predicted mid signal eₘ by adaptive filtering corresponding to that described for FIGS. 1 and 2. A 4-by-5 matrix is then applied to these signals to generate the output channels according to:

$$( \begin{matrix}{l}_{f} \\ {r}_{f} \\ c \\ {l}_{s} \\ {r}_{s}\end{matrix} ) = {U}_{45} ( \begin{matrix}\hat{m} \\ {e}_{m} \\ \hat{s} \\ e\end{matrix} )$$

The distribution may specifically seek to match the predictable part \hat{m} of the mid signal to the front side channels to provide an appropriate spatial experience (since the predictable mid signal \hat{m} represents elements of the mid signal that can also be derived from the side signals and which thus corresponds to non-centralized audio sources). Specifically, it has been found that advantageous performance can be achieved if the predicted signal power (the power from the predicted mid signal \hat{m}) in one or both of front side channels is at least twice as high as that of the center channel.

The distribution may further seek to predominantly distribute the non-predicted mid signal eₘ to the center channel to reflect that this is an element of the mid signal which does not correlate with the difference signal, i.e. which is unlikely to correspond to well defined non central audio sources. In particular, it has been found that advantageous performance can be achieved if the non-predicted signal power (the power from the non-predicted mid signal eₘ) in the center channel is at least twice as high as that of any spatial front center side channel (and typically also of any surround channel).

Furthermore, the distribution of the non-predicted side signal may be predominantly to the surround signals and may specifically ignore the front side signals to reflect the processing of the mid signal.

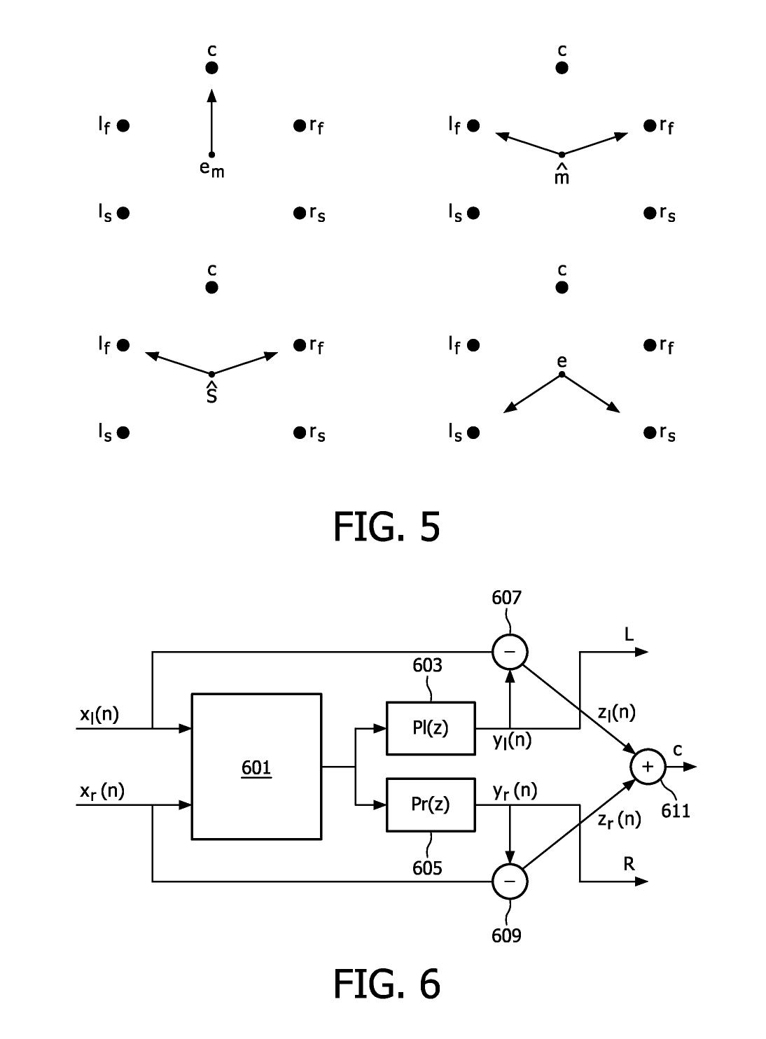

As a specific example, the following upmix matrix may be used:

$${U}_{45} = {U}_{0} ( \begin{matrix}1 & 0 & 1 & 0 \\ 1 & 0 & - 1 & 0 \\ 0 & \sqrt{2} & 0 & 0 \\ 0 & 0 & 0 & 1 \\ 0 & 0 & 0 & - 1\end{matrix} )$$

where Uₒ is a design constant that may be set to e.g. provide energy conservation. FIG. 5 illustrates this mapping.

In some systems a low-frequency channel may also be created. This may for example be done by applying a low-pass filter to both the left and right signal, summing these two signals and then using the sum signal for the low-frequency channel. The lowpass-filtered versions may be subtracted from the original input signals to create high-pass filtered signals. These high pass filtered signals can subsequently be used as input signals for the described upmix system.

FIG. 6 illustrates an example of another application using cross-channel predictive filtering. The system uses the approach to provide an improved separation of different audio sources and in particular seeks to provide an improved focus of central sound sources to the central channel with reduced components of these sources being present in the side channels. Such an approach may be specifically suitable for e.g. separation of a center speech source from a stereophonic mix. This may for example enhance the clarity of dialogue or other speech in stereo recordings.

In the example, a cross channel predictive filtering is used to determine a predicted signal for the left (and/or right) stereo signal based on a side signal. This predicted signal is indicative of how much of the left channel corresponds to non-central audio sources. The left (and/or right) signal is then compensated for the predicted signal to generate a non-predicted signal which corresponds to the part of the left (and/or right) signal that corresponds to central positions. The side channels are then predominantly generated from the predicted signal thereby suppressing any components of the left and right signals that relate to central sound sources. The central channel may further be generated from the non-predicted signals from the left and right channels.

The system comprises a mid-side processor 601 which receives the left and right signals xₗ(n), xᵣ(n) and proceeds to generate a difference signal x_{d}(n) according to:

x_{d}(n)=wₗxₗ(n)−wᵣxᵣ(n)

where the weights wₗ and wᵣ may e.g. be determined by a Principal Component Analysis (PCA) or may e.g. be constant, such as e.g. wₗ=wᵣ=1. In the latter case, the difference signal will contain only signal components that have not been panned exactly to the center in the stereo mix.

The resulting difference signal is then fed to two prediction circuits 603, 605 which each comprise an adaptive FIR filter that is used to generate the predicted signal components for respectively the left and the right signals. Thus the adaptive filter of the first prediction circuit 603 (for the left channel) is adapted such that the filtering of the difference signal optimizes a criterion (e.g., minimizes a cost function) indicative of the difference between the predicted signal and the left signal. The same approach is applied to the right channel by the second prediction circuit 605.

Specifically, for the first prediction circuit, the adaptive filter is adapted to minimize the energy of the left residual signal given by:

rₗ(n)=xₗ(n)−yₗ(n)

where

$${y}_{l} ( n ) = {\sum }_{k = 0}^{K - 1} {a}_{lk} {x}_{d} ( n - k )$$

represents the filtering of the adaptive filter.

The adaptation of the adaptive filter coefficients aₗₖ may e.g. be performed using the NLMS algorithm. The corresponding approach is performed by the second prediction circuit 605 resulting in the signal yᵣ(n).

The predicted signals for the left and right channels respectively are thus given by yₗ(n) and yᵣ(n). The predicted signal for the left channel yₗ(n) is fed to a subtraction circuit 607 which generates a non-predicted signal zₗ(n) for the left channel by subtracting the predicted signal yₗ(n) from the left channel signal xₗ(n). Similarly, the predicted signal for the right channel yᵣ(n) is fed to a subtraction circuit 609 which generates a non-predicted signal zᵣ(n) for the right channel by subtracting the predicted signal yᵣ(n) from the right channel signal xᵣ(n).

Thus, the process generates four signals corresponding to the predicted and non-predicted signal components for the right and left channels respectively where the predicted signal components are generated by predictive filtering of the difference signal.

The system then proceeds to distribute these four signals across three channels, namely the left, right and center channels (in the example the system comprises no surround channels). Indeed, in the specific example the predicted signals are predominantly fed to the right/left channel and indeed particularly advantageous performance has been found when the gain factor for a predicted signal to one of the left and right channels is at least twice the gain factor to the center channel. Thus, the predicted signal is predominantly fed to the side channels. Furthermore, the distribution of the non-predicted signals to the side channels is typically much lower and indeed in the specific example, the gain factor for the corresponding predicted signal to a side channel is at least twice that of a non-predicted signal. Indeed, in the example, the side channel comprises only a contribution from the non-predicted signals and comprises no contribution from the predicted signal. Accordingly, the side channels are devoid of any centralized sound source contributions as it comprises only signal components that are correlated with the difference signal.

Furthermore, the non-predicted signal components are distributed to the center channel and specifically non-predicted signal components from the left and right channels are in the specific example combined in a combiner 611 which yields the central channel C. However, in the example, any contribution from the predicted signals will be substantially reduced and in the specific example the predicted signals do not provide any contribution to the central channel.

It has in particular been found that particularly advantageous performance can be achieved for a gain factor for the non-predicted signals to the center channel of at least twice that of a predicted signal.

Also, it has in particular been found that particularly advantageous performance can be achieved when the non-predicted signal is distributed to the center channel with a gain factor of at least twice the gain factor that is applied to distribution of the non-predicted signal to a side channel. Thus, the non-predicted signal is predominantly distributed to the center channel.

The described system of FIG. 6 thus provides a highly efficient separation of central and side sound sources. Furthermore, it may proceed to substantially reduce or remove central sound sources from the side channels and focus these in the center channel. Such an approach may provide improved performance in many scenarios and may specifically allow improved clarity of central speech in stereo recordings.

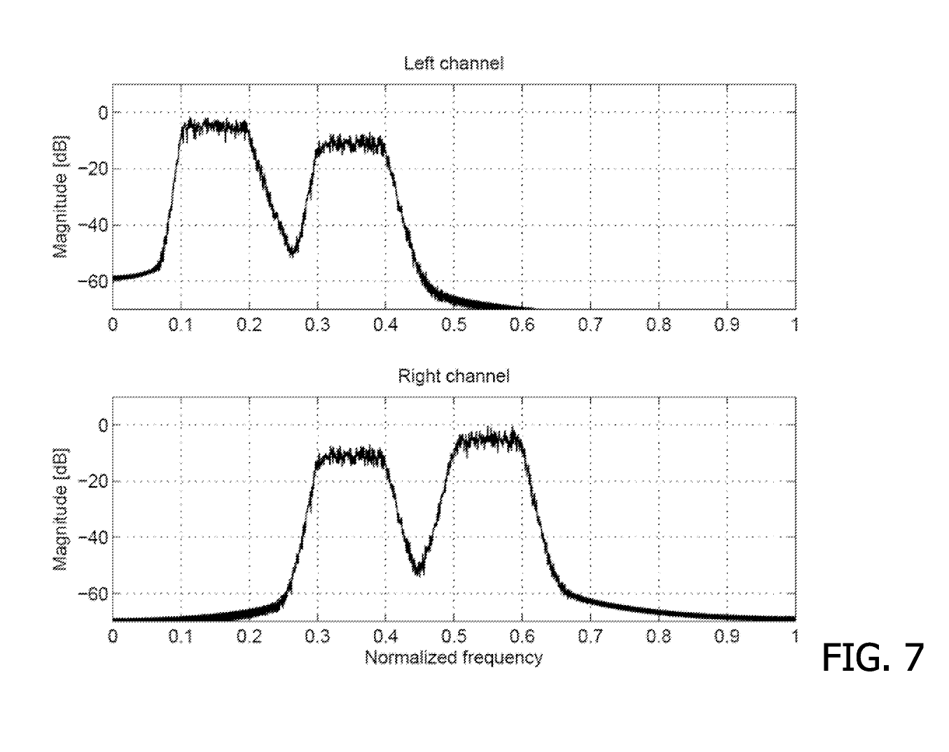

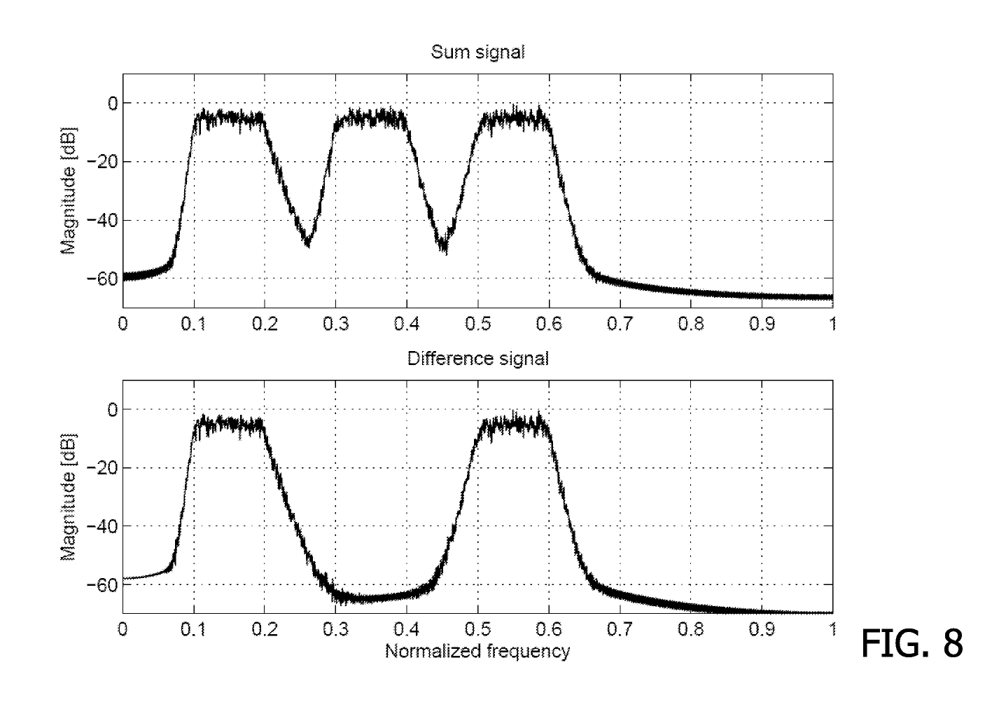

The operation of the system of FIG. 6 may be illustrated by a specific example. In the example a received stereo signal consists of three disjoint bands of noise. One of the noise bands is panned exactly to the center in the stereo image. The two other noise bands are panned to the extreme left and right in the image. The spectra of the signals are illustrated in FIG. 7. The difference signal is in this case computed using ωₗ=ωᵣ=1 and the spectrum of the difference signal is shown in FIG. 8 which also illustrates the spectrum of the sum signal for reference.

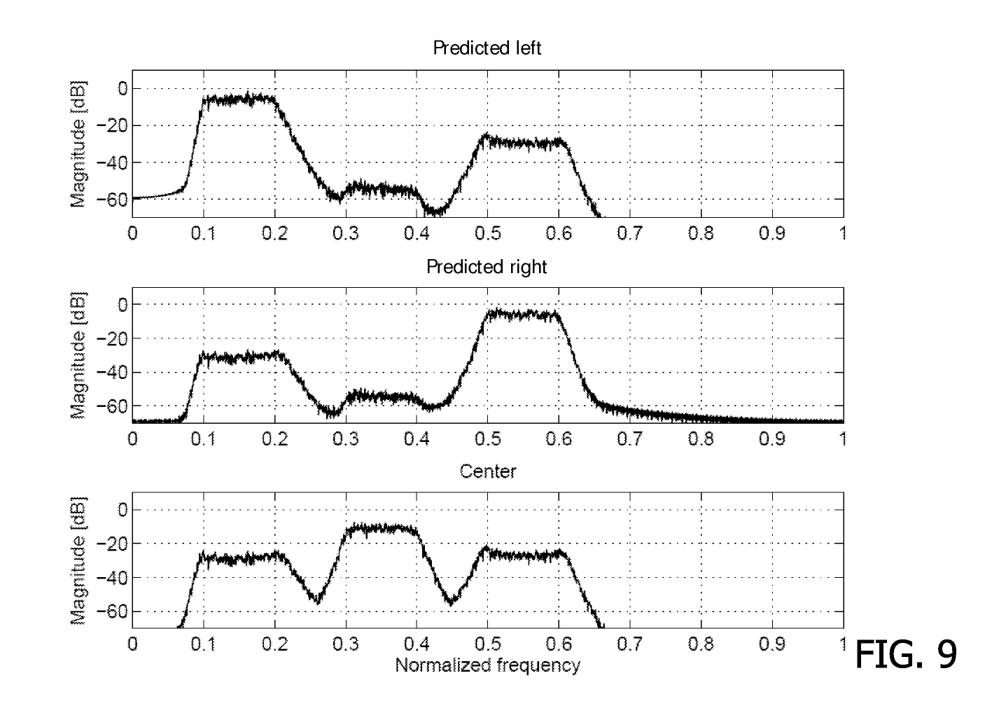

The spectra of the left and right predicted signals (corresponding to the left and right output channels) as well as the center channel signal are show in FIG. 9.

As illustrated, the approach achieves separation of the three components from the stereo mixture. In this synthetic example, the leakage of the center channel to the sides is at a very low level. The left and right channels leak to each other. However, the level of the leaking sound is more than 30 dB below the level of the desired sound. In addition, it is visible in FIG. 9 that the source panned to the center dominates the spectra of the residual signals (the non-predicted signals). Although some leakage occurs from the side signals to the center channel, the level is almost 20 dB below the level of the desired center source.

It will be appreciated that the above description for clarity has described embodiments of the invention with reference to different functional circuits and processors. However, it will be apparent that any suitable distribution of functionality between different functional circuits or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit or circuit, in a plurality of units or circuits or as part of other functional units or circuits. As such, the invention may be implemented in a single unit or circuit or may be physically and functionally distributed between different units, circuits, and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, circuits, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus for generating a set of output audio channels from a first set of audio channels, the apparatus comprising:
providing circuit (101) for providing the first set of audio channels;
prediction circuit (103) for generating a predicted signal for a first channel of the first set of audio channels by adaptive filtering of a signal of a second channel of the first set of audio channels by an adaptive filter;
circuit (105) for adapting the adaptive filter to minimize a cost function indicative of a difference between the predicted signal and a first signal of the first channel;
circuit (107) for generating a non-predicted signal for the first channel by compensating the first signal for the predicted signal;
distributing circuit (109) for generating the set of output audio channels by distributing at least the predicted signal and the non-predicted signal over the set of output audio signals, the distribution being different for the predicted signal and the non-predicted signal.

2. The apparatus of claim 1 wherein the providing circuit (101) is arranged to generate a difference signal from a first spatial channel and a second spatial channel, and wherein the first channel comprises the difference signal.

3. The apparatus of claim 2 wherein the distributing circuit (109) is arranged to distribute the predicted signal such that a predicted signal power in at least one spatial front side channel of the set of output audio channels is at least twice as high as a predicted signal power in any spatial surround channel or spatial front center channel of the set of output audio channels.

4. The apparatus of claim 2 wherein the distributing circuit (109) is arranged to distribute the non-predicted signal such that a non-predicted signal power in at least one spatial side channel or surround channel of the set of output audio channels is at least twice as high as a non-predicted signal power in a spatial front center channel of the set of output audio channels.

5. The apparatus of claim 4 wherein the distributing circuit (109) is arranged to distribute the non-predicted signal such that a variation in non-predicted signal power between any two channels of the spatial side channels and surround channels of the set of output audio channels is no more than 6 dB.

6. The apparatus of claim 1 wherein the providing circuit (101) is arranged to generate a sum signal from a first spatial channel and a second spatial channel, and wherein the second channel comprises the sum signal.

7. The apparatus of claim 1 wherein the providing circuit (101) is arranged to generate a sum signal from a first spatial channel and a second spatial channel, and wherein the first channel comprises the sum signal.

8. The apparatus of claim 7 wherein the distributing circuit (109) is arranged to distribute the non-predicted signal such that a non-predicted signal power in at least one spatial front center channel of the set of output audio channels is at least twice as high as a non-predicted signal power in any spatial front side channel of the set of output audio channels.

9. The apparatus of claim 9 wherein the distributing circuit (109) is arranged to distribute the predicted signal such that a predicted signal power in at least one spatial front side channel of the set of output audio channels is at least twice as high as a predicted signal power in a spatial front center channel of the set of output audio channels.

10. The apparatus of claim 1 wherein the providing circuit (101) is arranged to generate a difference signal from a first spatial channel and a second spatial channel, and wherein the second channel comprises the difference signal.

11. The apparatus of claim 10 wherein the first channel corresponds to one of the first spatial channel and the second spatial channel.

12. The apparatus of claim 11 wherein the distributing circuit (109) is arranged to distribute the predicted signal to a spatial channel of the set of output channels corresponding to one of the first spatial channel and the second spatial channels with a gain factor of at least twice a gain factor for the non-predicted signal.

13. The apparatus of claim 11 wherein the distributing circuit (109) is arranged to distribute the non-predicted signal to a spatial center channel of the set of output channels with a gain factor of at least twice a gain factor for a spatial channel of the set of output channels corresponding to the one of the first spatial channel and the second spatial channel.

14. The apparatus of claim 1 wherein the prediction circuit (103) is arranged to generate the predicted signal as a delayed predicted signal.

15. A method of generating a set of output audio channels from a first set of audio channels, the method comprising:
providing the first set of audio channels;
generating a predicted signal for a first channel of the first set of audio channels by adaptive filtering of a signal of a second channel of the first set of audio channels by an adaptive filter;
adapting the adaptive filter to minimize a cost function indicative of a difference between the predicted signal and a first signal of the first channel;
generating a non-predicted signal for the first channel by compensating the first signal for the predicted signal;
generating the set of output audio channels by distributing at least the predicted signal and the non-predicted signal over the set of output audio signals, the distribution being different for the predicted signal and the non-predicted signal.
